(19) United States
(12) Patent Application Publication
(10) Pub. No.: US 2002/0003988 A1
(43) Pub. Date: Jan. 10, 2002

(54) REMEDIATION METHOD

(76) Inventors: THOMAS MIKUS, HOUSTON, TX (US); HAROLD J. VINEGAR, HOUSTON, TX (US); ERIC DE ROUFFIGNAC, HOUSTON, TX (US)

Correspondence Address: DEL S CHRISTENSEN, SHELL OIL COMPANY, INTELLECTUAL PROPERTY, P O BOX 2463, HOUSTON, TX, 772522463

(21) Appl. No.: 09/080,684

(22) Filed: May 18, 1998

Related U.S. Application Data
(60) Provisional application No. 60/047,215, filed on May 20, 1997.

(51) Int. Cl. B09C 1/00

(52) U.S. Cl. 405/128.35; 405/128.85

(57) ABSTRACT

A method is provided to remove volatile contaminates from a contaminated volume of earth, the contaminated volume lying above a noncontaminated layer of earth, the method including the steps of: penetrating the contaminated volume with at least one wellbore so that a wellbore penetrates the contaminated volume and the noncontaminated layer; applying heat from the wellbore within the noncontaminated layer to the noncontaminated layer until the temperature of a substantial portion of the noncontaminated layer is about the boiling point of liquids within the noncontaminated layer; and applying heat from the wellbore within the contaminated volume to the contaminated volume wherein the temperature of the contaminated volume rises to about the boiling point of liquids in the contaminated layer after a substantial portion of the noncontaminated layer is about the boiling point of liquids within the noncontaminated layer at the pressure of the noncontaminated layer.

### RELATED APPLICATIONS

This application claims priority to U.S. patent application No. 60/047,215, filed on May 20, 1997.

### FIELD OF THE INVENTION

The invention relates to a in situ thermal desorption process for remediation of volatile contaminates.

### BACKGROUND TO THE INVENTION

Thermal desorption methods to remove volatile contaminates from soils insitu are suggested in, for example, U.S. Pat. Nos. 4,973,811, 5,076,727, 5,152,341, 5,190,405, 5,193,934, 5,221,827, and 5,271,693. Methods of applying heat include microwave and radio frequency electrical power along with resistance heating between electrodes; injection of hot gases, and conduction of electricity through the soil. Conductive heat transfer from heat injection wells are suggested in, for example, U.S. Pat. Nos. 5,190,405 and 5,271,693. U.S. Pat. No. 5,271,693 suggests a heater well through which vapors are extracted from the formation.

U.S. Pat. No. 4,984,594 disclose methods and equipment for remediation of shallow contamination by heating contaminated soil from the surface by a heater blanket. This method has the advantage of performing the remediation without disturbing the soil. This method is practical for contamination within about three feet of the surface, and is economical for sufficiently shallow contamination, but becomes more expensive as the depth of the contamination increases. It is also difficult to maintain a negative pressure within the soil at greater depths. Heater wells and vapor extraction wells are therefore more economical at greater depths, but numerous wells are required, and a considerable portion of each well is within non-contaminated soil. Expense of the wells and heat loss to non-contaminated soil therefore increase the cost of the remediation, although, the cost can still be considerably less than physically removing soil for decontamination.

Shallow slotted horizontal conduits buried below the depth of contaminated soil are suggested in U.S. Pat. No. 5,193,934. These conduits are used to inject combustion gases into the earth to vaporize and sweep contamination upward, to a vacuum at the surface, where vaporized contaminates are collected and removed from the combustion gases. This method can potentially cause a rise in pressure within the contaminated zone, which can cause migration of contaminates into the noncontaminated zone.

U.S. Pat. No. 5,244,310 discloses a system for remediation of contaminated soil wherein heat is applied from spikes inserted into the soil through a vapor collection blanket on the surface above the contaminated soil. Vaporized contaminates are removed from slotted hollow spikes also inserted into the soil thorough the vapor collection blanket. This system, like the systems that rely on application of heat from the surface above the contaminated soil, is only economical for a limited depth of contamination.

U.S. Pat. No. 5,169,263, suggests a system for in situ soil decontamination wherein heat is applied from the surface of the contaminated soil, and contaminates are removed through slotted pipes buried below the contamination. A vacuum is maintained within the slotted pipes. Again, contamination below one to two feet in depth become relatively expensive to remove by this method.

There still remains a need for more economical remediation methods. It is therefore an object of the present invention to provide a method to remove contaminates from a contaminated soil by insitu heating wherein contaminants that are below one to two feet of soil may be heated without heating the soil from the surface.

### SUMMARY OF THE INVENTION

This and other objects are accomplished by a method to remove volatile contaminates from a contaminated volume of earth, the method comprising the steps of: placing a plurality of essentially horizonal conduits in the vicinity of the contaminated soil; heating the contaminated soil by providing combustion gases to at least one essentially horizonal conduits wherein the combustion gases pass through the conduit and are not injected into the contaminated soil and contaminates are vaporized by the heating; and removing vaporized contaminates from the contaminated soil by drawing the vaporized contaminates into at least one essentially horizonal conduit though perforations in that conduit. In a preferred embodiment of the present invention, the combustion gases are passed through perforated conduits and contaminates are removed by maintaining a vacuum within the perforated conduits, thereby drawing the vaporized contaminates into the perforated conduits. In this preferred embodiment, the vaporized contaminates are removed from the perforated conduits, and treated by means such as incineration, and treatment by contact with an activated carbon bed along with compression in a vacuum pump before being expelled to the atmosphere. The present invention avoids the rise in pressure mentioned above and maintains a pressure in the contaminated zone below atmospheric levels and therefore prevents spreading of contaminates into the noncontaminated soils.

### BRIEF DESCRIPTION OF THE DRAWINGS

FIG. 1 is a side view of the system of the present invention.

FIG. 2 is a top view of the system of the present invention.

### DESCRIPTION OF A PREFERRED EMBODIMENT

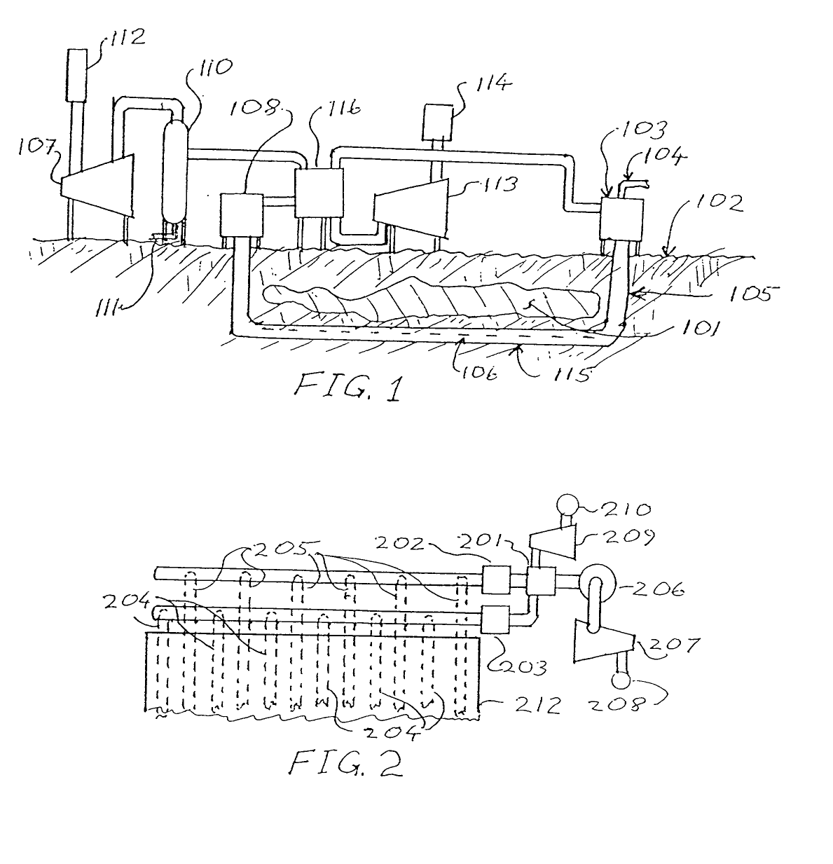

Referring now to FIG. 1, a side view of equipment capable of carrying out the method of the present invention is shown. Contaminated soil 101 is shown below a surface 102. A burner 103 oxidizes a fuel from a fuel supply conduit 104 to produce combustion gases that are routed through a vertical segment of conduit 105 to a horizontal section 115 of conduit that is buried in the vicinity of the contaminated soil. The horizontal section comprises perforations 106, the perforations effective to provide communication between the soil in the vicinity of the conduit and the interior of the conduit. This contaminated soil could be at a considerably depth below the surface, or may be only one foot or less deep. At depths of one to about 10 feet, the horizontal conduits may be may be placed in the desired position by digging a narrow trench, placing the conduit in the trench, and then back filling the trench with preferably clean soil. Digging a trench has the advantage of providing a continuous line at which the bottom of the trench can be sampled to ensure that the horizontal conduits are below the depth of significant contamination. It is preferred that the back-filled soil have a higher permeability than the original soil to accelerate removal by providing vertical planes from which to draw the contaminates. It is also preferred that the horizontal conduits be below contaminated soil to minimize the possibility that contaminates are driven deeper into the soil by generation of steam by heating of the contaminated soil. At depths greater than about 10 feet, the horizontal segments may be drilled as horizontal wellbores.

Contaminates are vaporized, along with water, in the vicinity of the horizontal conduits by heat from the combustion gases. These vaporized contaminates are drawn into the horizontal wellbore through perforations or slots 106 through walls of the horizontal conduit. A negative pressure is maintained within the horizontal conduit by drawing the combustion gases and vaporized water and contaminates out using a blower 107. The combined combustion gases and contaminates are routed preferably first through an oxidizer 108. This oxidizer is preferably a catalytic oxidizer with integral heat exchange. Supplemental fuel may be required to maintain a sufficient temperature in the oxidizer.

A heat exchanger 116 is provided to preheat combustion air using gases from the incinerator 108. From the heat exchanger, condensed liquids may be removed from the cooled gases by a knock out pot 110. Liquids from the knock out pot 111 will generally be clean liquids and because the contaminates have been oxidized to essentially carbon dioxide and water in the oxidizer. Further treatment of the gases are therefore minimal. The cooled dry gases from the knock out are then compressed by the blower 107 and exhausted to the atmosphere through a muffler 112. The sequence of the treatment steps is not critical, and other known steps for treatment of the combined combustion gases and vaporized contaminates may be provided, such as contact with activated carbon or scrubbing with adsorbent to remove components such as sulfur oxides.

Combustion air that has been filtered by an intake filter 114 may be compressed by a combustion gas compressor 113 prior to routing the combustion air through the heat exchanger 116. From the heat exchanger, the combustion gas is routed to the burner 103 for combustion with fuel gas. Alternatively, natural draft could be utilized instead of the compressor 113 to provide air for the burner.

Referring now to FIG. 2, a partial plan view of equipment capable of carrying out the present invention is shown. In the embodiment of FIG. 2, combustion gas inlets 204 for the horizontal conduits are alternating with conduit outlets 205 at each end of the pattern of horizontal conduits. The essentially horizontal conduits are therefore laid out essentially parallel with direction of flow in adjacent conduits in opposite directions. With this arrangement, distances between the combustion air heat exchanger 201, the oxidizer 202, and the burner 203, are minimal, and pressure drops are therefore minimized. A knock out pot 206 is shown to remove condensed liquids from cooled gases from the conduit outlets. A blower 207 maintains a negative gauge pressure, and exhausts gases to atmosphere through a muffler 208. A combustion air blower provides a positive pressure to move air through the heat exchanger and burner and from a filter 210. FIG. 2 shows one half of the pattern, with a mirror image of the system shown in FIG. 2 provided at the other end of the pattern. The horizontal conduits could be, for example, 100 to 200 feet long, and may completely cover the contaminated region with a single pattern, or the conduits and surface equipment could be moved to decontaminate portions of the contaminated region in stages.

An alternative to alternating inlets would be to have combustion gas inlets along one half of the pattern, and outlets from the horizontal conduits on the other half of the pattern at each end of the pattern. With this arrangement, only one header is needed along each end of pattern and the oxidizer and heat exchanger and other equipment are placed in the middle of the pattern at each end of the pattern. Pressure drops and pipe requirements are thereby minimized. The configuration of FIG. 2 is preferred because the contaminated soil is heated more evenly with the combustion gases flowing in alternating directions.

Another alternative is to provide combustion gas to alternating conduits, preferably at a positive pressure, and to remove vaporized contaminates from alternating conduits. The conduits provided with combustion gases in this alternative are preferably not perforated and operated at a pressure above atmospheric pressure. If the combustion gas conduits are perforated in this embodiment, they are preferably operated at no more than a slight positive pressure, to ensure that contaminates are not moved from the vicinity of the horizontal conduits by positive pressure from the horizontal conduits. In this case the vapor collecting conduits can be maintained at a low enough pressure such that the average pressure in the contaminated region is still below atmospheric pressure.

The volatile contaminates which may be removed from contaminated soils by the method of the present invention are a wide variety of contaminates. Contaminates that are typically considered to be volatile, such as gasoline, can be remediated by the present invention, but much heavier hydrocarbons and higher temperature boiling point materials can also be volatilized and removed by the present invention. PCBs, mercury, and heavy gas oils, for example, can be removed as vapors by the present invention. Normal boiling points of these materials are well above temperatures that can be achieved insitu, but water that is present will vaporize, and even a limited vapor pressure of the contaminate will result in removal of the contaminate with sufficient amounts of steam.

Heat is be imparted to the contaminated volume, and preferably to the layer of noncontaminated soil below the volume of contaminated soil, by conduction from the wellbore. Wellbore heaters useful for heating the wellbore in provide heat for conduction into the formation are known. For example, gas fired wellbore heaters are taught in U.S. Pat. Nos. 2,902,270, and 3,181,613, incorporated herein by reference. Electrical wellbore heaters are disclosed in, for example, U.S. Pat. No. 5,060,287, incorporated herein by reference. A preferred gas fired wellbore heater is disclosed in, for example, U.S. Pat. No. 5,255,742, incorporated herein by reference. Also, surface burners can be used to generate hot combustion gases for injection into the horizontal conduits.

Heat is applied to the contaminated volume by conduction, and is preferably applied from a wellbore which also serves as a source of suction to remove contaminate containing vapors from the wellbore. In this preferred embodiment, vaporized contaminates are therefore transported from the formation directly to the wellbore for recovery without the possibility that they are transported to cooler soil where the contaminates could condense, causing an increased concentration of contaminates where condensation occurs.

Additional wellbores equipped to insert heat and to remove vapors can also optionally be provided. Also, containment barriers may be provided around the lateral boundaries of the contaminated soil to eliminate inadvertent lateral movement of contaminates away from the perforated conduits. Surface heaters could also optionally be provided to heat the contaminated soil from the surface. Heating of the contaminated soils using surface heaters is preferred when the contaminated soil is relatively close to the surface.

The contaminated volume is shown as underneath an overburden, but if the soil is to be heated to the surface, insulation can be provided above at the surface. Further, if the contaminated volume extends to near the surface, then it could be beneficial to provide a vapor seal over the surface to prevent excessive amounts of air from being pulled into the contaminated volume. If the contaminated volume extends to the surface, surface heaters could be provided to apply heat from the surface.

Vapors are preferably removed through wellbores extending into the contaminated volume, and these vapors can then be treated to remove contaminants by methods known in the art. For example, thermal oxidizers can be provided to oxidize the contaminates, and then the remaining vapor stream could be passed through carbon beds to collect remaining contaminants and/or the oxidation products of the contaminants. A blower will generally be provided to maintain a low absolute pressure within the wellbore and formation. Lower pressures are beneficial because lower pressures decrease the temperatures at which water and contaminates are vaporized in the contaminated soil and because they prevent spreading of contaminates into the noncontaminated region.

The pattern of heater and suction conduits preferably extends past the peripheral of the contaminated soil. Like the layer below the contaminated volume, this ring surrounding the peripheral of the contaminated volume is preferably heated to about the boiling point of liquids in that ring prior to heating the contaminated volume to above the boiling point of the liquids in the contaminated volume. Alternatively, the contamination could be laterally contained by barriers such as pylons driven into the ground or cement barriers poured in narrow trenches.

We claim:

1. A method to remove volatile contaminates from a contaminated volume of earth, the method comprising the steps of:
placing a plurality of essentially horizontal conduits in the vicinity of the contaminated soil;
heating the contaminated soil by providing combustion gases to at least one essentially horizontal conduits wherein the combustion gases pass through the conduit and are not injected into the contaminated soil and contaminates are vaporized by the heating; and
removing vaporized contaminates from the contaminated soil by drawing the vaporized contaminates into at least one essentially horizontal conduit through perforations in that conduit.

2. The method of claim 1 wherein the combustion gases are provided to the same conduits into which conduit vaporized contaminates are drawn.

3. The method of claim 1 wherein the combustion gases are provided to at least one conduit into which conduit vaporized contaminates are not drawn.

4. The method of claim 2 wherein the conduits into which combustion gases are provided are not perforated conduits.

5. The method of claim 2 wherein the plurality of essentially horizontal conduits are laid out essentially parallel with direction of flow in adjacent conduits in opposite directions.

6. The method of claim 1 wherein the plurality of essentially horizontal conduits are placed between about one and about 10 feet from the surface.

7. The method of claim 6 wherein the plurality of essentially horizontal conduits are placed in the vicinity of the contamination by placing the conduits in trenches.

8. The method of claim 1 further comprising placing a vapor seal on the surface above the essentially horizontal conduits.

9. The method of claim 1 further comprising the step of placing insulation above the essentially horizontal conduits.

10. The method of claim 1 further comprising the step of heating the contaminated soil using a surface heater placed above the soil surface.
